(19) United States
(12) Patent Application Publication
(10) Pub. No.: US 2022/0005226 A1
(43) Pub. Date: Jan. 6, 2022

(54) CAMERA CALIBRATION USING MEASURED MOTION

(71) Applicant: Asensus Surgical US, Inc., Durham, NC (US)

(72) Inventors: Tal Nir, Haifa (IL); Lior Alpert, Haifa (IL); Gal Weizman, Haifa (IL)

(21) Appl. No.: 17/368,759

(22) Filed: Jul. 6, 2021

Related U.S. Application Data
(60) Provisional application No. 63/048,177, filed on Jul. 5, 2020.

(51) Int. Cl. G06T 7/80; G06T 7/00

(52) U.S. Cl. CPC G06T 7/85; G06T 2207/10021; G06T 7/0012

(57) ABSTRACT

Intrinsic and extrinsic calibration parameters are determined in real time for a camera positioned to capture images of a surgical site in a body cavity. The camera is positioned on a manipulator arm and used to capture a plurality of frames of images of the surgical site using the at least one camera while moving the camera within the body cavity. 3D position information corresponding to positions of the camera is recorded during capture of said images. A plurality of features between two or more frames of the captured images are matched, and a 3D structure of the plurality of features is reconstructed using multi-frame triangulation. A penalty measure is estimated using a reprojection error. The distance in the image plane between the projected 3D feature and the measurement. Intrinsic calibration parameters are estimated for the at least one camera, and refined to minimize the penalty measure.

### BACKGROUND

Camera calibration solutions typically involve some unique known patterns (fiducials) presented in front of the camera in different poses. Depending on the context in which the camera is to be used, this process is one that can delay use of the camera, occupy personnel, and it makes it difficult to perform “on the fly” calibrations. For example, in robotic laparoscopic surgery a camera (e.g. an endoscopic/laparoscopic camera) is positioned in a body cavity to capture images of a surgical site. It would be advantageous to calibrate the camera on the fly using the measured robot arm movements without occupying the operating room staff with the time-consuming calibration task, and with having to hold a calibration pattern in front of the camera in the operating room.

This application describes a system and method for calibrating a camera (or several cameras in rigid fixture as in a stereo rig) on the fly, without having to spend time for a calibration phase which uses a special pattern, but rather working with a (mostly) static unknown (in advance) scene, using measured camera motion (relative motion is enough).

While the disclosed system and method are particularly useful for use in robotic systems, including those used for surgery, the proposed method can be used to calibrate any 3D camera for which movements are known using kinematics or sensors (e.g. using an inertial measurement unit “IMU” to determine camera movements).

The system may also be used for UAV/drone applications, in which case a camera or set of cameras may be calibrated when flying over a mostly static scene.

### BRIEF DESCRIPTION OF THE DRAWINGS

FIG. 1 is a schematic block diagram depicting an embodiment of the disclosed calibration system.

### DETAILED DESCRIPTION

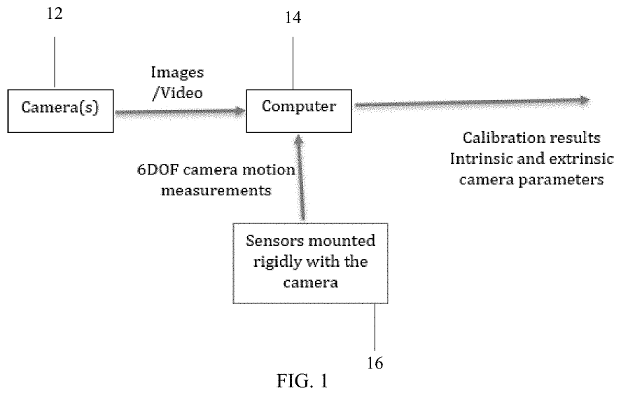

Referring to FIG. 1, the calibration system comprises:

A camera 12, stereo camera, or several cameras fixed together. The camera is removably mounted to a manipulator arm, which may be of the type provided on the Senhance Surgical System marketed by Asensus Surgical, Inc.

A location sensor 16 that is mounted rigidly on or with the camera. For example, this may be one or more sensors of the robotic manipulator arm that measure the robotic arm movements, determine camera position using kinematics, or measure movement of the camera (e.g. using IMU). In some embodiments, two or more of these concepts may be combined.

A computing unit 14 that receives the images/video from the camera(s), and computes the camera calibration parameters. The computing unit is programmed with an algorithm that, when executed, analyzes the images/video captured by the camera and receives input from the sensors 16, and estimates the calibration results for the camera(s) internal parameters and the relative poses (for stereo or several cameras).

More specifically, the algorithm estimates the following camera parameters:
Focal length (fx,fy)
Principal point(cx,cy) of each camera
Rotation between the cameras
Radial distortion (k) (for each camera separately)

In addition, the 3D world points are estimated (using multi-view triangulation) in order to evaluate the reprojection error of the calibration process.

The algorithm for calculating the camera parameters may be formulated using following steps:

1. Extract feature points from an image captured using the camera. This may be done using image processing techniques known in the art (e.g. SURF, BRISK, HARTS, etc.). The article Bay et al, SURF: Speeded Up Robust Features, Computer Vision and Image Understanding 110 (2008) 3460359 (incorporated by reference) describes one such technique.

2. Match the features between two or more frames of the image.

3. Reconstruct the 3D structure of the features using multi-frame triangulation.

4. Estimate a penalty measure using the reprojection error, measuring the distance in the image plane between the projected 3D feature and the measurement, the penalty measure should be a robust distance measure (see Michael Black et al, On the Unification of Line Processes, Outlier Rejection, and Robust Statistics with Applications in Early Vision, International Journal of Computer Vision, which is incorporated herein by reference) in order to account for outliers (such as those coming from mismatched points or from non-static points)

5. RANSAC (Random Sample Consensus) may also be incorporated in the process

6. Refine the camera parameters in order to minimize the penalty measure

The camera intrinsic parameters may contain: focal lengths, camera center, skew, radial distortion. The extrinsic parameters may contain the 3D angle between two cameras in a stereo setup.

Some rough initial guess for the camera parameters is required for the process.

Advantages of the disclosed method are that it does not require a specific calibration stage, calibration can be done on the fly during regular use (assuming the regular use is in front of a mostly static scene) and does not require a calibration pattern. Thus, for a camera used in surgery, in can be used to perform calibration during the course of the surgical procedure. It thus provides an effective solution for cameras which need an online calibration process.

We claim:

1. A system for determining calibration parameters for a camera in real time during use of the camera to capture images of a surgical site in a body cavity, comprising:
at least one camera positioned on a manipulator arm;
at least one sensor rigidly coupled to the camera for determining three dimensional motion of the at least one camera; and
a processor programmed with an algorithm that, when executed, analyzes images captured by the at least one camera of a scene within a body cavity, receives input from the sensor, and estimates at least one of internal calibration parameters for the at least one camera.

2. A method for determining calibration parameters for a camera in real time during use of the camera to capture images of a surgical site in a body cavity, comprising:
positioning at least one camera on a manipulator arm;
capturing a plurality of frames of images of the surgical site using the at least one camera while moving the camera within the body cavity;
receiving 3D position information corresponding to positions of the camera during capture of said images;
matching a plurality of features between two or more frames of the captured images reconstructing a 3D structure of the plurality of features using multi-frame triangulation;
estimating a penalty measure using a reprojection error, measuring the distance in the image plane between the projected 3D features and the measurement;
estimating intrinsic calibration parameters for the at least one camera.
